(19) United States
(12) Patent Application Publication
(10) Pub. No.: US 2002/0089185 A1
(43) Pub. Date: Jul. 11, 2002

(54) Device for fastening a first part to a stationary second part

(76) Inventors: Andre Hessling, Lippstadt (DE); Bodo Wisch, Bremen (DE)

Correspondence Address: BIRCH STEWART KOLASCH & BIRCH, PO BOX 747, FALLS CHURCH, VA, 22040-0747, US

(21) Appl. No.: 10/020,171

(22) Filed: Dec. 18, 2001

(30) Foreign Application Priority Data
Dec. 18, 2000 (DE) 100 63 035.9

(51) Int. Cl. E05C 19/00; E05C 21/00

(52) U.S. Cl. 292/80; 292/2

(57) ABSTRACT

The present invention relates to a device for fastening a first part to a stationary second part of a vehicle, wherein the first part is removably connected via a fastening means to the second part, wherein the fastening means comprises a spring element and the first part is coupled via the spring element to the second part.

### BACKGROUND OF THE INVENTION

The present invention relates to a device for fastening a first part to a stationary second part of a vehicle, wherein the first part is removably connected to the second part via a fastening means.

From DE-A-197 30 269 and DE-A-199 00 267 devices for fastening a first part to a stationary second part of an aircraft are known, wherein the first part is removably connected to the second part via a fastening means. The first part can be configured as an airplane panel which can be fastened to a C-shaped profile forming the second part. The first part is pivotally supported on the fastening means or the second part such that the first part can be moved by its own weight into a vertical position in which installation work can be performed in the area of the opening in the ceiling, which is to be closed later by the panel, and can then be pivoted into a horizontal locking position in which the opening is closed. It is a drawback of the known device that the first part, in the horizontal locking position, is supported on the second part via a rigid fastening means. This results in a relatively rigid arrangement which may lead to undesired breakage in weak areas of the fastening means, in particular due to the mechanical stresses occurring during flying operations.

### SUMMARY OF THE INVENTION

According to the present invention a device for fastening a first part to a stationary second part of an airplane is provided such that a permanently reliable connection is realized without the first part and the second part being subjected to unacceptably high mechanical stresses.

The device according to the invention is characterized in that the fastening means comprises a spring element, and that the first part is coupled to the second part via the spring element.

The advantage presented by the device according to the invention is that the first part is coupled to the second part via a flexible spring element. Owing to the damping effect of the spring element in particular forces occurring as a result of dynamic vibrating stresses can be absorbed such that the first part is subjected to a smaller mechanical stress. Thus the service life of the first part can be increased. Further, the flexible spring element leads to a tolerance compensation which has a positive effect in particular during installation of the first part. Moreover, changes in the shape of the first or the second part, which occur in the course of time, can be advantageously compensated for such that, on the whole, a stable and relatively stressfree connecting arrangement is provided.

According to a preferred aspect of the present invention the first part is coupled to the fastening means via the spring element, wherein the fastening means is non-positively connectable with the second part. The end of the spring element facing the first part is pivotally connected to the first part such that the first part is advantageously arranged in such a way that it is pivotable about a pivoting axis spaced apart from the second part. Thus the required pivoting range of at least 90° can be realized.

According to a preferred embodiment of the present invention the spring element is of arcuate configuration, wherein a portion of the spring element is in surface contact with a holding surface of a basic body of the fastening means and rests against said holding surface. In connection with a locking element the spring element can thus be connected to the spring element. By means of a supporting surface extending at an acute angle to the line of action of the fastening means the spring element is held in an arcuate or bulged shape which leads in particular to a reduction of the dynamic stresses. The spring element has non-linear or preferably progressive spring properties such that generation of a resonant frequency is prevented.

According to a further aspect of the present invention the spring element is in surface contact and braced with the holding surface of the basic body such that a portion of the kinetic energy produced by mechanical stress can be “destroyed” to form frictional energy. Thus the force level can, on the whole, be kept smaller over a large frequency range.

### BRIEF DESCRIPTION OF THE DRAWINGS

Hereunder an embodiment of the present invention is explained in detail with reference to the drawings in which:

FIG. 1 shows a perspective view of a fastening means for fastening a first part to a second stationary part (not shown), wherein the fastening means is coupled to the first part via a spring element,

FIG. 2 shows a cross-section, taken along line II-II of FIG. 1, of the fastening means in the condition as fastened to the second part (profile),

FIG. 3 shows a cross-section of the first part, wherein the spring element is connected to the second part and the fastening means is shown as being pivoted into a plurality of relative positions,

FIG. 4 shows a perspective view of the spring element, and

FIG. 5 shows a top view of the fastening means shown in FIG. 1.

### DESCRIPTION OF THE PREFERRED EMBODIMENT

The device according to the invention is preferably used in aircraft, in particular airplanes, where considerable acceleration forces act upon the components.

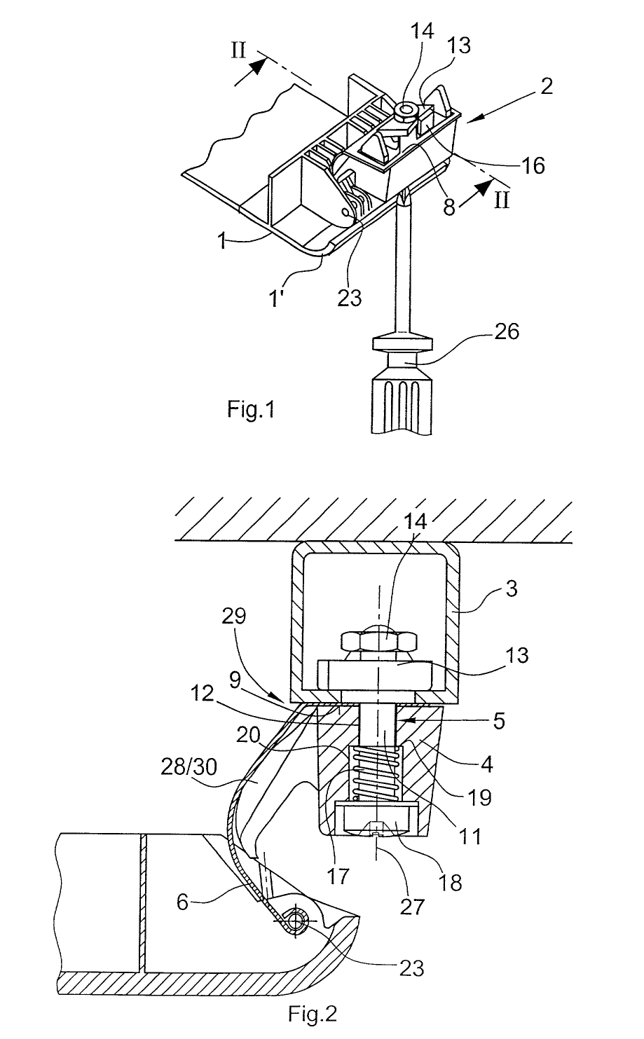

A first part 1, which can be configured e.g. as airplane panel or function table, is removably connected to a second part 3 via a fastening means 2. The first part 1 is shown in FIG. 1 only as an edge-side section. The fastening means 2 is arranged in an offset manner on both sides of opposite edge sides 1′ along the edge sides 1′. The second part 3 can be configured as C-shaped profile rail.

The first part 1 is configured as a plate-shaped plastic part and comprises a plurality of reading-lamp openings and openings for air jets. Fastening of the first part 1 is effected at the opposite edge sides 1′ which extend parallel to the corresponding second parts 3.

The fastening means 2 for removable fastening the first part 1 to the stationary second part 3 essentially comprises a rectangular basic body 4 which can be fixed to the second part 3 via a screw union 5, and a flexible spring element 6 which can be fixed to the basic body 4 via the screw union 5 and is pivotally connected to the first part 1 via a hinge 7.

As can be seen from FIG. 4, the spring element 6 is of arcuate configuration and comprises, on a side averting the first part 1, a plane end section 8 provided with passages, the end section 8 being in surface contact with and positionable on a holding surface 9 of the basic body 4. For this purpose the end section 8 comprises passages 10 corresponding with raised portions on the holding surface 9 such that a definite positioning of the spring element 6 relative to the basic body 4 is realized.

After positioning of the end section 8 of the spring element 6 on the holding surface 9, the screw union 5 is attached. For this purpose a screw 11 is inserted through a guide bore 12 of the basic body 4 and connected in the area of the holding surface 9 to a trapezoidal fixing nut 13 and a stop nut 14. The fixing nut 13 is, in an unlocked position, arranged between two stops 15 and 16 as seen in longitudinal direction of the basic body 4. Due to the fact that a biased helical spring 17 is arranged between a head 18 of the screw 11 and a stop shoulder 19 of a basic body 4 recess 20 facing the first part 1, the fixing nut 13 and the end section 8 of the spring element 6, respectively, is, in the initial position (unlocked position), pressed onto the holding surface 9.

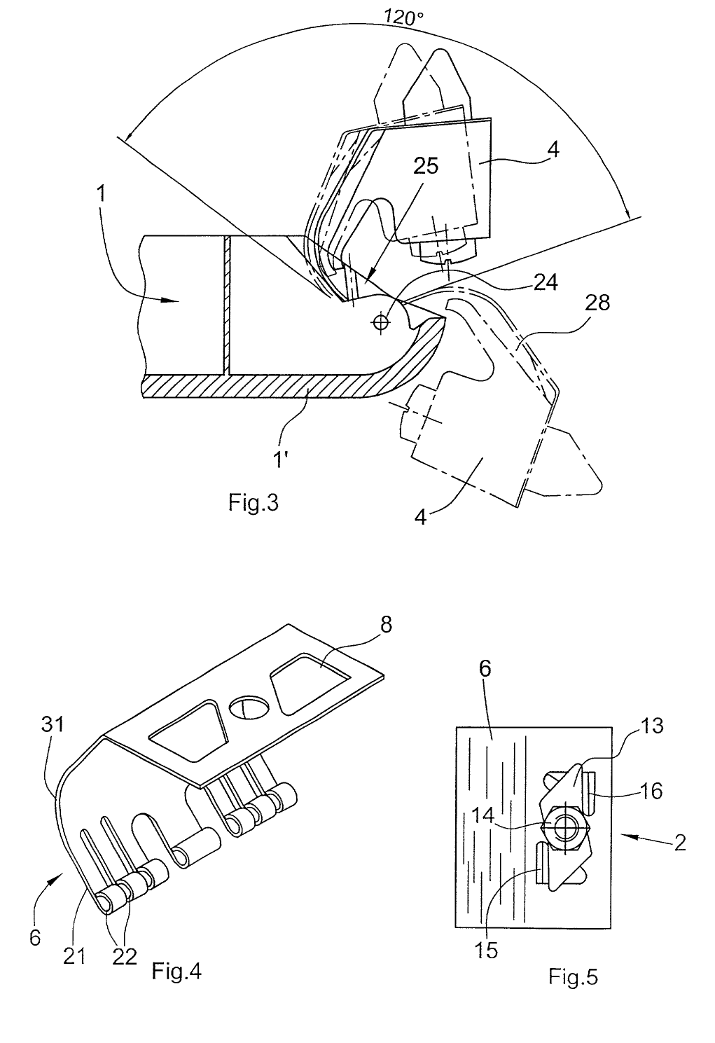

A spring element 6 end facing the first part 1 is configured as a strap hinge 21 and rotatably connected to the first part 1 via a pin 24 extending through aligned openings 22 of the strap hinge 21 on the one hand and openings 23 of the first part 1 on the other hand. As can be clearly seen in FIG. 3, a pivoting angle range of 120° can be covered owing to provision of bulges 25 of the first part 1 on the one hand and articulation of the first part 1 by means of the spring element 6 on the other hand.

For installing the first part 1 to the second part 3, after the end section 8 of the spring element 6 has been supported, in the manner described above, on the basic body 4 of the fastening means 2, the first part 1 can be set into a partial-locking position by placing the end section 8 or the holding surface 9 against the outer surface of the C-shaped part 3 which is open in downward direction and inserting the fixing nut 13 into the slot of the C-shaped profile 3 and subsequently rotating said fixing nut 13. The fixing nut 13 is rotated by approximately 60° by turning the screw 11 with a screw driver 26. In this partial-locking position the first part 1 essentially extends in vertical direction such that installation work can be performed at the opening, which is to be closed later, between the rail-shaped second parts 3 extending in parallel. Then the first part 1 is pivoted by approximately 90° into a position in which the opening is closed and fastened on the opposite edge side of the first part 1 via an identical fastening means 2 to the corresponding second part 3. By further turning of the screw 11 a non-positive connection between the basic body 4 and the second part 3 is realized, as is described in detail in DE 199 00 267. The stops 15,16 prevent the fixing nut 13 from being further rotated.

Alternatively, the first part 1 can be directly set into the final locking position on an edge side 1′ such that displacement along the rail-shaped second part 3 is no longer possible. In the final locking position the spring element 6 is non-positively fastened to the second part 3 via the screw union 5. For obtaining a bulged shape of the spring element 6, a supporting surface 28 extending relative to a line of action 27 (longitudinal axis of the guide bore 12) projects from the basic body 4, the supporting surface 28 extending from an inner edge 29 of the holding surface 9 thus forming a bulge 30 at an acute angle. The bulged supporting surface 28 extends up to a middle fillet area 31 of the spring element 6. Thus the spring element 6 develops a non-linear spring characteristic line, in particular a progressive spring characteristic line.

In the final locking position the spring element 6 forms a connecting part between the first part 1 and the second part 3, the spring element 6 exercising a damping effect. In particular in the case of dynamic vibrating stresses forces may be absorbed without any resonant frequency occurring.

The spring element 6 is preferably configured as a metal leaf spring made of sheet-metal material, the end section 8 of the leaf spring resting on the holding surface of the plastic basic body 4.

In particular the change in the form of the spring element 6 allows absorption of forces in X and Y direction, see FIG. 2. Forces can further be compensated for in a direction oriented vertically to this direction along the hinge 7 or the edge side 1′ of the first part 1. Preferably, both manufacturing tolerances and mechanical stresses caused by old age of the first and second parts 1,3 can be absorbed.

Although a preferred embodiment of the invention has been specifically illustrated and described herein, it is to be understood that minor variations may be made in the device without departing from the spirit and scope of the invention, as defined in the appended claims.

What is claimed is:

1. Device for fastening a first part (1) to a stationary second part (3) of a vehicle, the first part (1) being removably connected to second part (3) via a fastening means (2), wherein the fastening means (2) comprises a spring element (6) and wherein the first part (1) is coupled to the second part (3) via the spring element (6).

2. Device according to claim 1, wherein the first part (1) is pivotally connected to the spring element (6).

3. Device according to claim 1, wherein the spring element (6) is of arcuate configuration and wherein a portion of the spring element (6) is in surface contact with and rests on a holding surface (9) of a basic body (4) of the fastening means (2).

4. Device according to claim 1, wherein the holding surface (9) comprises a supporting surface (28) extending at an acute angle to a line of action (27) of the fastening means (2), on which supporting surface (28) rests the spring element (6).

5. Device according to claim 1, wherein the supporting surface (28) is of arcuate and/or bulged configuration.

6. Device according to claim 1, wherein the spring element (6) is supported by a locking element (11,13), which fixes the basic body (4) to the second part (3), of the fastening means (2) in a loss-safe manner on the basic body (4), and, in a locking position of the first part (1), is braced with the second part (3) by actuation of the locking element (11,13).

7. Device according to claim 1, wherein the spring element (6) and the first part (1), for pivotable connection thereof, form a strap hinge (21).

8. Device according to claim 1, wherein the spring element (6) is configured as a leaf spring having a non-linear spring characteristic line.

9. Device according to claim 1, wherein the spring element (6) is made from sheet-metal material and rests on the supporting surface (28) such that the spring element (6) has a parabolic or progressive spring characteristic line.

10. Device according to claim 1, wherein the first part (1) is configured as an airplane panel which, at least in some portions, comprises bulges (25) on two parallel edge sides (1′) for articulation to the spring element (6) such that the airplane panel (1) is pivotable at a concave angle to the spring element (6).
